(19) United States
(12) Patent Application Publication
(10) Pub. No.: US 2007/0260760 A1
(43) Pub. Date: Nov. 8, 2007

(54) Method of loading device driver used with open firmware to optimize boot time and required memory

(76) Inventors: Hsien-i Chang, Austin, TX (US); Mark Elliott Hack, Austin, TX (US); James Arthur Lindeman, Austin, TX (US); Muhamed Sadic, Cedar Park, TX (US)

Correspondence Address: IBM CORP (YA);C/O YEE & ASSOCIATES PC, P.O. BOX 802333, DALLAS, TX, 75380, US

(21) Appl. No.: 11/385,927

(22) Filed: Mar. 21, 2006

(51) Int. Cl. G06F 3/00

(52) U.S. Cl. 710/8

(57) ABSTRACT

A method is provided for loading device drivers in a computer system having a set of devices, when Open Firmware is implemented to boot the system. A set of stub device drivers are initially created, one for each device attached to the computer system. A stub driver comprises a reduced form of the complete driver for its corresponding device, wherein each stub driver is capable of providing device tree properties of its corresponding device. The method further comprises loading each of the stub drivers into the system, to respectively create device tree properties for the devices in response to a specified implementation of the Open Firmware. The loaded stub driver of a particular device is used to trigger loading of the complete driver for the particular device, only when the particular device is required for use by the specified Firmware implementation.

### BACKGROUND OF THE INVENTION

1. Field of the Invention

The invention disclosed and claimed herein generally pertains to an improved method for loading device drivers, in connection with implementation of Open Firmware in a computer system. More particularly, the invention pertains to a method of the above type wherein stub device drivers are created for use in implementing Open Firmware, rather than the currently used complete drivers. Even more particularly, the invention pertains to a method of the above type that is characterized by a two-phase procedure, in order to optimize boot time and the amount of memory required.

2. Description of the Related Art

It is common for a computer system to be provided with firmware of a type that controls the computer before a computer operating system has begun execution. The main tasks of such firmware are to test the computer hardware, and to start up or boot the operating system. However, in an open-systems environment, the task of loading the operating system can be significantly complicated by the presence of user installed I/O devices. If new I/O devices can be added to the system at any time, for use in loading the operating system, then the firmware must have a way to acquire boot drivers for such devices.

In order to meet this need, a hardware-independent firmware known as Open Firmware has been developed. Open Firmware uses a code that is compiled into Fcode, rather than the machine language of any particular computer architecture. As a result, Open Firmware code included in an I/O card or other device can be executed by any computer system that uses Open Firmware. Moreover, the drivers for such devices are usable on any system that runs Open Firmware. Accordingly, new devices may be added to an Open Firmware system and used for booting or message display, without modification to the Open Firmware retained in the system ROM.

The standard IEEE 1275 provides specifications for use of Open Firmware to boot an operating system or other client program in a computer system. This standard requires that in order to proceed with a booting procedure, the device driver codes from all devices that have valid boot ROMs must be loaded into the system. The system can then evaluate the boot codes, in order to (1) initialize the devices, (2) create device tree properties, and (3) make each of the devices usable for the Open Firmware, and also for the operating system or other client program that is to be started up by the booting procedure.

Previously, the evaluation of boot code on a large number of devices or adapters has had the undesirable side effect of increasing the firmware memory footprint, as well as considerably extending the time required to boot the system. These effects occur even when the Open Firmware does not need to use all the devices being evaluated. They can also occur when a device or adapter does not provide a considerable amount of function. Accordingly, the Open Firmware architecture allows for driver instancing, wherein the code is loaded once, and only the data associated with each device or adapter is created for each driver instance. This practice reduces the memory footprint, or amount of memory that is needed, and provides the required device initialization referred to above. However, such practice does not resolve the boot time issues, nor is it useful for situations in which devices use different versions of boot ROM driver code. Moreover, it is still necessary to create device tree properties for devices attached to a system, whenever Open Firmware is implemented to boot the system.

### SUMMARY OF THE INVENTION

The invention generally pertains to a method and apparatus wherein a set of stub device drivers are created, one for each device attached to a computer system that is affected by implementation of Open Firmware to boot the system. A stub driver comprises a shortened or reduced form of the complete driver for its corresponding device or adapter. However, the stub driver retains the capability to create device tree properties for its corresponding device, as required for Open Firmware implementation and by client programs loaded by the implementation. Moreover, a stub driver is able to trigger the loading of the complete driver of its corresponding device, in order to make such device fully functional for use with the Firmware or the client program, if necessary. One useful embodiment of the invention is directed to a method for loading device drivers in a computer system having a set of devices, wherein each device has a driver located in a ROM on the device itself, and the system is configured to run Open Firmware. The method comprises the step of initially generating a stub device driver for each of the devices, wherein each stub driver is capable of providing device tree properties of its corresponding device. The method further comprises loading each of the stub drivers into the system, to respectively create device tree properties for the devices in response to a specified implementation of the Open Firmware. The loaded stub driver of a particular device is used to trigger loading of the complete driver for the particular device, only when the particular device is required for use by the specified Firmware implementation.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a schematic diagram illustrating a configuration including an Open Firmware component and a computer or data processing system, in which an embodiment of the invention may be implemented.

FIG. 2 is a block diagram showing a data processing system that may be used in the configuration of FIG. 1 to implement embodiments of the invention.

FIG. 3 is a flow chart illustrating features of an embodiment of the invention.

### DETAILED DESCRIPTION OF THE PREFERRED EMBODIMENT

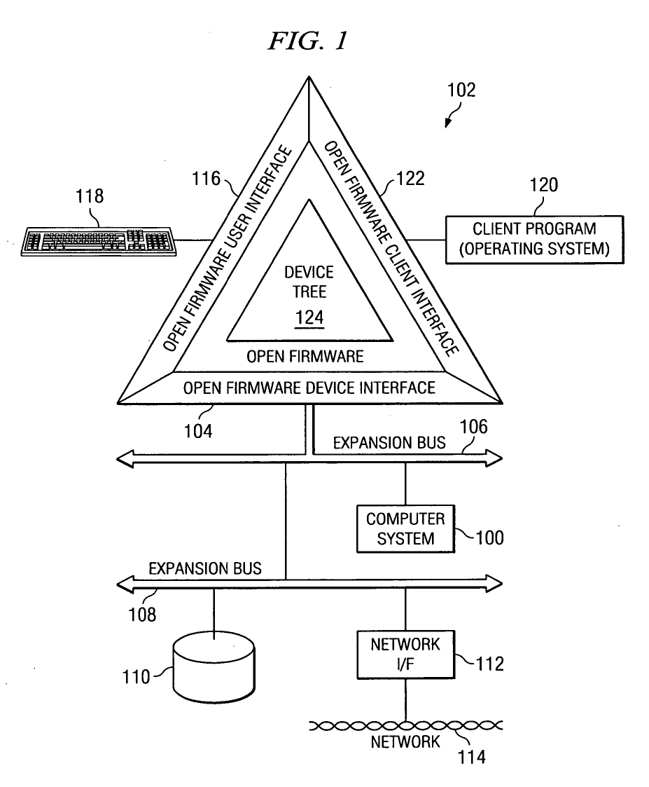

Referring to FIG. 1, there is shown a schematic representation of an Open Firmware component 102, wherein the Firmware is connected to a computer or data processing system 100 through a Device Interface 104 and a PCI expansion bus 106. FIG. 1 also shows other components and devices connected to computer system 100 through a PCI expansion bus 108, such as a data storage device 110 and a network interface device 112 coupled to a network 114.

Open Firmware component 102 is a hardware-independent firmware that is accessed by a user by means of a Forth-based shell interface. FIG. 1 shows Open Firmware component 102 having a User Interface 116, to enable a user to interact with the Firmware by operating a user interface device 118 or the like. The user may thereby instruct Open Firmware 102 to boot an operating system or other client program 120 into computer system 100, through Firmware Interface 122.

Referring further to FIG. 1, there is shown a device tree 124 associated with the Open Firmware. Whenever the Firmware is implemented to load a client program 120, a device tree 124 must be constructed that indicates the device tree properties of each I/O device attached to computer system 100. Previously, the device tree was constructed from information obtained by loading the entire or complete driver of each device into the system. As described above, the complete driver of a device had to be loaded, even if the device was not needed for the Firmware implementation or for operation of the client program.

As a first phase of an embodiment of the invention, a stub device driver is created for each I/O device or adapter attached to computer system 100. A stub driver for a particular device is substantially limited to the portion of the complete driver that furnishes the device tree properties for the particular device.

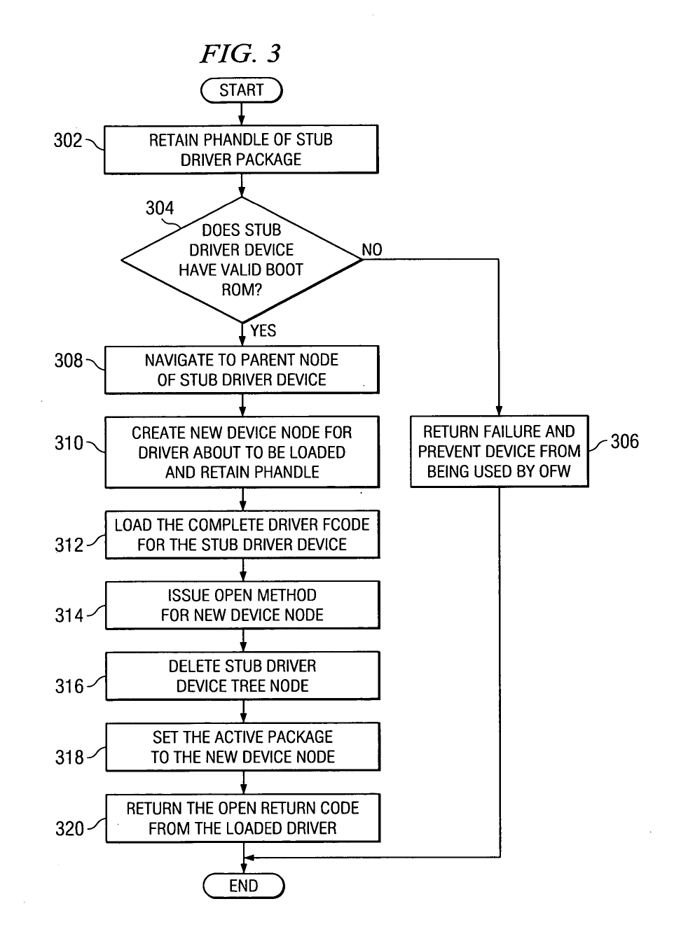

In order to use any device of system 100 for a Firmware implementation or for a loaded client program, an Open method defined by IEEE 1275 must be called for the device. Accordingly, each stub driver is further provided with the capability to respond to an Open method call that is directed to its corresponding device. Upon recognizing such call, the stub driver will trigger the loading of the complete driver from the ROM of its corresponding device. The complete driver will thereby be loaded into the device tree node for such corresponding device. The Open method will then be called, thus triggering activation of a second phase driver contained in the device ROM, to make the device fully functional for Open Firmware use. This procedure is described further in connection with FIG. 3.

After a set of stub drivers having the above characteristics has been created for all of the devices, the stub drivers are placed in a suitable stub driver repository, such as an accessible storage device.

A firmware implementation for computer system 100 will contain a list of devices keyed off the device/vendor and/or subsystem identifiers, as specified by the PCI architecture. This list will be used during a PCI probing process that constructs the device tree from the loaded device drivers, as described above. In accordance with the embodiment of the invention, the precedence of device driver loading is set to search the stub driver repository first, and then the adapter and lastly the generic driver for the adapter class.

The procedure of the embodiment described above enables a device tree to be created for a Firmware implementation that contains all the properties specified by IEEE 1275, while at the same time reduces memory footprint and boot time cost. The cost of loading a complete driver for a device is incurred only when the device is actually required for firmware implementation or a loaded client program. Since a device node is compliant with the architecture, the stub driver corresponding to the device is transparent to the firmware and to the client. The embodiment only requires the existence of stub drivers and a minor modification to the precedence of adapter driver loading. For areas of the device tree in which no Open method is issued on any of the devices, and which are merely navigated to search for properties, no change is required since the stub drivers provide sufficient information to maintain architectural compliance and code compatibility.

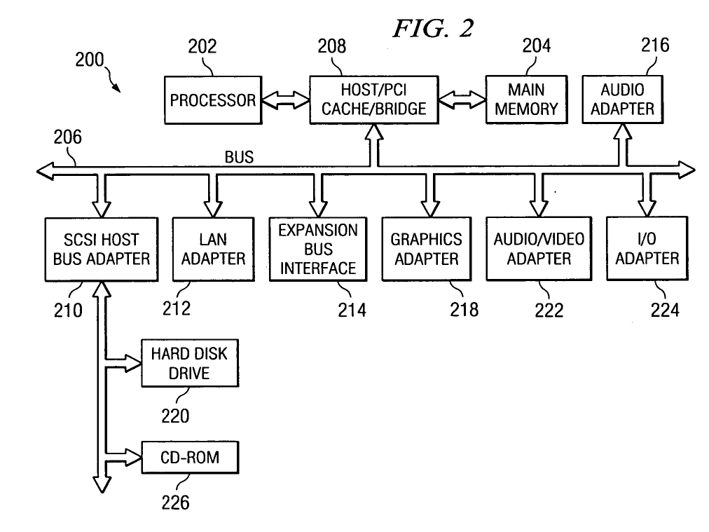

Referring to FIG. 2, there is shown a block diagram of a generalized data processing system 200 which may be used as computer system 100, in implementing embodiments of the present invention. Data processing system 200 exemplifies a computer in which code or instructions for implementing the processes of the present invention may be located. Data processing system 200 usefully employs a peripheral component interconnect (PCI) local bus architecture. FIG. 2 shows a processor 202 and main memory 204 connected to a PCI local bus 206 through a Host/PCI bridge 208. PCI bridge 208 also may include an integrated memory controller and cache memory for processor 202.

Referring further to FIG. 2, there is shown a local area network (LAN) adapter 212, a small computer system interface (SCSI) host bus adapter 210, and an expansion bus interface 214 respectively connected to PCI local bus 206 by direct component connection. Audio adapter 216, a graphics adapter 218, and audio/video adapter 222 are connected to PCI local bus 206 by means of add-in boards inserted into expansion slots. One or more I/O adapters 224 may also be inserted into PCI bus 206 as plug-in devices. SCSI host bus adapter 210 provides a connection for hard disk drive 220, and also for CD-ROM drive 226.

An operating system runs on processor 202 and is used to coordinate and provide control of various components within data processing system 200 shown in FIG. 2. The operating system, which may be a commercially available operating system, is loaded into system 200 by Open Firmware 102. Instructions for the operating system and for applications or programs are located on storage devices, such as hard disk drive 220, and may be loaded into main memory 204 for execution by processor 202.

From the above description, it will be understood that each stub driver has an associated package, from which a device tree node can be created that has all the properties of the corresponding device. In addition, the stub driver package contains logic that can be used to load the complete driver code of the corresponding device. A procedure or sequence carried out by this logic, shown in FIG. 3, would be commenced if the Open method was called for the corresponding device. As described above, this occurs when the device must become fully functional, in order to support a particular Firmware implementation or client program.

Referring to FIG. 3, the first step 302 of the logic sequence is to retain the package handle (phandle) of the associated stub driver package. The phandle is a cell-sized datum identifying the package of a particular driver. Following step 302, it is necessary to determine whether the device corresponding to the stub driver has a valid boot ROM, as shown by decision block 304. A device has a valid boot ROM only if its ROM contains a driver for the device. If there is no valid boot ROM, a failure is returned and the device is prevented from being used by the Open Firmware, as shown by function block 306.

Referring further to FIG. 3, if the device corresponding to the stub driver is found to have a valid boot ROM, step 308 shows that the system navigates to the device tree parent node for the corresponding device. Then, at step 310 a new device node is created for the stub driver, which was about to be loaded or moved into memory for execution. Following step 310, the complete driver FCODE of the device is loaded, as shown by step 312. After loading of the complete driver, an Open method is issued for the new device node at step 314. The stub driver device tree node is then deleted, in accordance with step 316, and the new device node is set to become the active package, as shown by step 318. Step 320 shows the return of the open return code from the loaded driver, to end the sequence. If this return cannot be made, a failure is returned.

After loading is completed, all device properties specified by IEEE 1275 are created during post-processing. In the associated PCI probe logic, a search is added of the internal driver library for the check for a valid IEEE 1275 booted ROM.

The invention can take the form of an entirely software embodiment or an embodiment containing both hardware and software elements. In a preferred embodiment, the invention is implemented in software, which includes but is not limited to Firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In a computer system having a set of devices and configured to run Open Firmware, wherein each device has a driver located in a ROM on the device itself, a method for loading device drivers comprising the steps of:
initially generating a stub device driver for each of said devices, wherein each stub driver is capable of providing device tree properties of its corresponding device;
loading each of said stub drivers into said system, in order to respectively create device tree properties for each of said devices in response to a specified implementation of said Open Firmware; and
using the loaded stub driver of a particular device to trigger loading of the complete driver of said particular device, only when said particular device is required for use by the specified Firmware implementation.

2. The method of claim 1, wherein:
each of said stub drivers corresponding to one of said devices has an associated package that contains a logic tool for use in loading the complete driver of its corresponding device.

3. The method of claim 1, wherein:
said method further comprises inserting each of said stub drivers, after it has been generated, into a stub driver repository.

4. The method of claim 3, wherein:
said specified Firmware implementation requires construction of a device tree by means of a probing process, wherein said probing process includes initially searching said stub driver repository.

5. The method of claim 1, wherein:
at least some of said devices comprise I/O adapters for use with said computer system.

6. The method of claim 1, wherein:
the time required to load a given one of said stub drivers is substantially less than the time required to load the complete driver of the device corresponding to said given stub driver.

7. The method of claim 1, wherein:
at least some of said devices comprise plug-in devices.

8. The method of claim 1, wherein:
said particular device is required for use by said specified Firmware implementation, if said particular device is required for the operation of a client program loaded into said system by said specified Firmware implementation.

9. In a computer system having a set of devices and configured to run Open Firmware, wherein each device has a driver located in a ROM on the device itself, a computer program product for loading device drivers comprising:
first instructions for initially generating a stub device driver for each of said devices, wherein each stub driver is capable of providing device tree properties of its corresponding device;
second instructions for loading each of said stub drivers into said system, in order to respectively create device tree properties for each of said devices in response to a specified implementation of said Open Firmware; and
third instructions for using the loaded stub driver of a particular device to trigger loading of the complete driver of said particular device, only when said particular device is required for use by the specified Firmware implementation.

10. The computer program product of claim 9, wherein:
each of said stub drivers corresponding to one of said devices has an associated package that contains a logic tool for use in loading the complete driver of its corresponding device.

11. The computer program product of claim 9, wherein:
said computer program product further comprises fourth instructions for inserting each of said stub drivers, after it has been generated, into a stub driver repository.

12. The computer program product of claim 9, wherein:
said specified Firmware implementation requires construction of a device tree by means of a probing process, wherein said probing process includes initially searching said stub driver repository.

13. The computer program product of claim 9, wherein:
at least some of said devices comprise I/O adapters for use with said computer system.

14. The computer program product of claim 9, wherein:
each of said device drivers comprises software written in Fcode for managing selected I/O operations of its corresponding device.

15. The computer program product of claim 9, wherein:
at least some of said devices comprise plug-in devices.

16. In a computer system having a set of devices and configured to run Open Firmware, wherein each device has a driver located in a ROM on the device itself, apparatus for loading device drivers comprising:
a first processing component for initially generating a stub device driver for each of said devices, wherein each stub driver is capable of providing device tree properties of its corresponding device;
a second processing component for loading each of said stub drivers into said system, in order to respectively create device tree properties for each of said devices in response to a specified implementation of said Open Firmware; and
a third processing component for using the loaded stub driver of a particular device to trigger loading of the complete driver of said particular device, only when said particular device is required for use by the specified Firmware implementation.

17. The apparatus of claim 15, wherein:
each of said stub drivers corresponding to one of said devices has an associated package that contains a logic tool for use in loading the complete driver of its corresponding device.

18. The apparatus of claim 16, wherein:
at least some of said devices comprise I/O adapters for use with said computer system.

19. The apparatus of claim 18, wherein:
each of said device drivers comprises software written in Fcode for managing selected I/O operations of its corresponding device.

20. The apparatus of claim 16, wherein:
at least some of said devices comprise plug-in devices.
